(19) United States
(12) Patent Application Publication
(10) Pub. No.: US 2007/0156812 A1
(43) Pub. Date: Jul. 5, 2007

(54) DYNAMIC AUDIO DATA REROUTING SYSTEM, ARCHITECTURE AND METHOD

(75) Inventors: Yung-Hui Hou, Taipei (TW); Tzu-Lung Chuang, Taipei (TW); Chao-Kuang Yang, Taipei (TW)

Correspondence Address: MADSON & AUSTIN;GATEWAY TOWER WEST, SUITE 900, 15 WEST SOUTH TEMPLE, SALT LAKE CITY, UT, 84101, US

(73) Assignee: ACER Inc., Taipei (TW)

(21) Appl. No.: 11/558,709

(22) Filed: Nov. 10, 2006

(30) Foreign Application Priority Data
Dec. 30, 2005 (TW) 094147667

(51) Int. Cl. G06F 15/16

(52) U.S. Cl. 709/204

(57) ABSTRACT

An audio data rerouting system, architecture and method thereof are disclosed in the present invention. The system includes a first audio device and a second audio device; a first audio driver and a second audio driver, respectively corresponding to the first and second audio devices; and an audio data rerouting module; wherein, as the first audio device is in use, through the audio data rerouting module, audio data received from the first audio driver are dynamically rerouted to the second audio driver so as to redirect the audio data to the second audio device.

### FIELD OF THE INVENTION

The present invention is related to a dynamic audio data rerouting system, architecture and method, and more particularly to a dynamic audio data rerouting system, architecture and method capable of dynamically rerouting the received audio data to the user-selected audio device.

### BACKGROUND OF THE INVENTION

In the prior art audio data processing system, the settings of the audio input device and audio output device are preset before the multimedia application program is launched. If a user desires to change these settings (for example, select the other audio input device or the other audio output device), the running application program has to be terminated and then restarted after the changes to the settings have been effected. In other words, the current audio data processing technique can not allow the settings of the audio input device or the audio output device to be dynamically changed while the multimedia application program is processing input audio data or outputting audio data.

With the progression of the audio processing technique, the multimedia application programs that provide instant messaging service, such as MSN, Skype, Yahoo Messenger, are designed to be updatable, so that the services of internet phone and online video conference have become more and more popular. However, the above-mentioned instant messaging service still bears the disadvantages that the settings of the audio input device and the audio output device can not be dynamically changed. This would undermine the versatility of the multimedia application program. Despite the convenience of employing the real-time communication capability of the instant messenger software, the user can not be satisfied without a smooth and simple real-time communication tool.

For example, when a user desired to use the MSN instant messenger, the main program of MSN instant messenger will be launched first. The MSN instant messenger will issue an invitation to a video conference by sending an invitation voice message. After the user accepts the invitation voice messing by clicking the mouse, the built-in speaker and microphone can be used to conduct a conference call with on-line friends. However, when the user desires to use an external speaker and microphone, such as a VOIP phone to conduct a conference call, the user has to select the “tool” function from the main menu of MSN instant messenger and then activate the audio/video tuning wizard. By the audio/video tuning wizard, the user can select the desired VOIP phone as the audio input/output device and use the selected audio input/output device to conduct a conference call. After the VOIP phone is no longer in use, the settings of the audio input/output device have to be reset to the default built-in speaker and microphone through the audio/video tuning wizard. Otherwise, the user may not receive the invitation voice message from the default built-in speaker.

The foregoing switching procedure for the settings of the audio input/output device needs more than ten steps to complete. This would cause severe inconvenience to the user. Therefore, there is a need to develop an audio data rerouting system, architecture and method for dynamically rerouting the audio data while the instant messenger is in use, so that the user does not have to execute redundant steps to change the settings of the audio input device and audio output device.

### SUMMARY OF THE INVENTION

An object of the present invention is to provide a dynamic audio data rerouting system.

Another object of the present invention is to provide a dynamic audio data rerouting architecture.

Another yet object of the present invention is to provide a dynamic audio data rerouting method.

A first aspect delineating the first mode of the present invention is directed to an audio data rerouting system including a first audio device and a second audio device, a first audio driver and a second audio driver being respectively corresponding to the first audio device and the second audio device, and an audio data rerouting module. When the first audio device is in use, the audio data received by the first audio driver can be rerouted to the second audio driver through the audio data rerouting module so as to redirect the audio data to the second audio device.

A second aspect delineating the first mode of the present invention is directed to an audio data rerouting system including a first audio device and a second audio device, a virtual audio driver, a multimedia application program, and an audio data rerouting module, in which the audio data from the first audio device or the audio data from the second audio device may be rerouted to the multimedia application program through the audio data rerouting module.

A first aspect delineating the second mode of the present invention is directed to an audio data rerouting architecture including a physical layer having a first audio device and a second audio device, an audio driver layer having a first audio driver and a second audio driver being respectively corresponding to the first audio device and a second audio device, and a multimedia application layer having an audio data rerouting module. When the first audio device is in use, the audio data received by the first audio driver can be rerouted to the second audio driver through the audio data rerouting module so as to redirect the audio data to the second audio device.

A second aspect delineating the second mode of the present invention is directed to an audio data rerouting architecture including a physical layer having a first audio device and a second audio device, an audio driver layer having a virtual audio driver, and a multimedia application layer having a multimedia application program and an audio data rerouting module, in which the audio data from the first audio device or the audio data from the second audio device can be rerouted to the multimedia application program through the audio data rerouting module.

A first aspect delineating the third mode of the present invention is directed to an audio data rerouting method for use in the foregoing audio data rerouting system including a first audio device and a second audio device, a first audio driver and a second audio driver, and an audio data rerouting module. The audio data rerouting method includes the steps of: transmitting audio data to the first audio driver; selectively transmitting the audio data to the first audio device or the audio data rerouting module; rerouting the audio data received by the audio data rerouting module to the second audio driver through the audio data rerouting module; and outputting the audio data through the second audio device.

A second aspect delineating the third mode of the present invention is directed to an audio data rerouting method for use in the foregoing audio data rerouting system including a first audio device and a second audio device, a virtual audio driver, a multimedia application program, and an audio data rerouting module. The audio data rerouting method includes the steps of: inputting audio data; transmitting the audio data to the audio data rerouting module; rerouting the audio data to the virtual audio driver; and transmitting the audio data to the multimedia application program.

Now the foregoing and other features and advantages of the present invention will be best understood through the following descriptions with reference to the accompanying drawings, wherein:

### BRIEF DESCRIPTION OF THE DRAWINGS

FIG. 1 illustrates a block diagram showing the audio data rerouting system according to a first embodiment of the present invention;

FIG. 2 illustrates a block diagram showing the audio data rerouting system according to a second embodiment of the present invention;

FIG. 3 illustrates a flowchart showing the audio data rerouting method according to a first embodiment of the present invention; and

FIG. 4 illustrates a flowchart showing the audio data rerouting method according to a second embodiment of the present invention.

### DETAILED DESCRIPTION OF THE PREFERRED EMBODIMENT

Several preferred embodiments embodying the features and advantages of the present invention will be expounded in following paragraphs of descriptions. It is to be realized that the present invention is allowed to have various modification in different respects, all of which are without departing from the scope of the present invention, and the description herein and the drawings are to be taken as illustrative in nature, but not to be taken as limitative.

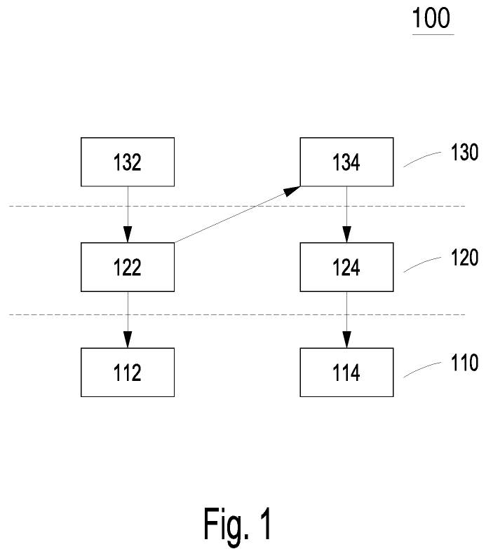

FIG. 1 is a block diagram showing the dynamic audio data rerouting system according to a first embodiment of the present invention. The dynamic audio data rerouting system 100 shown in FIG. 1 includes a plurality of layers 110, 120, 130. According to the first embodiment of the present invention, the reference numeral 110 denotes a physical layer, the reference numeral 120 denotes an audio driver layer, and the reference numeral 130 denotes a multimedia application layer. The first layer 110 may include a plurality of audio devices. In the present embodiment, the first layer 110 may include a first audio device 112 and a second audio device 114. Both of the first audio device 112 and the second audio device 114 may be implemented with an audio output device, such as a built-in speaker or an external speaker. Specifically, the first audio device 112 is a built-in speaker and the second audio device 114 is an external speaker which may be selected by the user.

The second layer 120 may include a plurality of audio drivers. In the present embodiment, the second layer includes a first audio driver 122 and a second audio driver 124 which are respectively corresponding to the first audio device 112 and the second audio device 114. The first audio driver 122 is configured to selectively transmit the audio data to the corresponding first audio device 112 or the audio data rerouting module 134. For example, when the audio data is desired to be outputted through the default built-in speaker (that is, the first audio device 112), the first audio driver 122 may transmit the audio data to the first audio device 112. On the other hand, when the audio data is desired to be outputted through the user-selected external speaker (that is, the second audio device 114), the first audio driver 122 may transmit the audio data to the audio data rerouting module 134 and drive the second audio device 114 through the second audio driver 124.

The third layer 130 may include an audio data rerouting module 134 for receiving the audio data from the first audio driver 122. As stated above, the audio data rerouting module 134 may dynamically reroute the audio data to the second audio driver 124 according to the user-selected external speaker (that is, the second audio device 114), so that the second audio device 114 may output audio data. In the present embodiment, the audio data rerouting module 134 is configured to automatically detect the user settings of audio input/output device. When the audio data rerouting module 134 receives audio data, the received audio data can be rerouted to the audio driver being corresponding to the user-selected audio device. Alternatively, the audio data rerouting module 134 may be driven by other programs to reroute the received audio data to the audio driver being corresponding to the user-selected audio device.

The third layer 130 may further include a multimedia application program 132 for processing audio data. For example, the multimedia application program 132 may be implemented with a Windows Multimedia application program pioneered by the Microsoft Corporation. The multimedia application program 132 is configured to set the first audio device 112 as a default audio device, and set the corresponding first audio driver 122 as the default audio driver. Afterwards, everytime the multimedia application program 132 is launched, the audio data is set to be transmitted to the default audio driver (that is, the first audio driver 122), and then selectively transmitted to the first audio device 112 or the audio data rerouting module 134.

In the present embodiment, the audio data rerouting module 134 may further include a user interface (not shown). By the user interface, the user may set the second audio device 114 as a user-selected audio device. The audio data rerouting module 134 may reroute the audio data to the corresponding second audio driver 124 according to the user-selected audio device. When one of the first audio device 112 and the second audio device 114 is in a working state, the other one of the first audio device 112 and the second audio device 114 will be in an idle state in order to allow the audio data to be dynamically outputted through the first audio device 112 or the second audio device 114. When the user selects the second audio device 114, the audio data received by the first audio driver 122 is rerouted to the second audio driver 124 through the audio data rerouting module 134 so as to redirect the audio data to the second audio device 114.

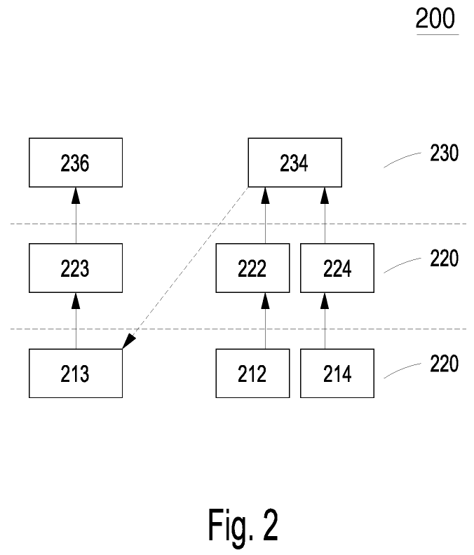

FIG. 2 illustrates a block diagram showing the dynamic audio data rerouting system according to a second embodiment of the present invention. The dynamic audio data rerouting system 200 shown in FIG. 2 includes a plurality of layers 210, 220, 230. In the present embodiment, the first layer 210 is a physical layer, the second layer 220 is an audio driver layer, and the third layer 230 is a multimedia application layer. The first layer 210 may include a plurality of audio devices. In the present embodiment, the first layer 210 may include a first audio device 212 and a second audio device 214. Both of the first audio device 212 and the second audio device 214 may be implemented with an audio input device, such as a built-in microphone or an external microphone. Specifically, the first audio device 212 is a built-in microphone and the second audio device 214 is an external microphone which may be selected by the user. The dynamic audio data rerouting system 200 may further include a virtual audio device 213 which corresponds to a virtual audio driver 223.

The second layer 220 may include a plurality of audio drivers. In the present embodiment, the second layer 220 may include a first audio driver 222 and a second audio driver 224 being respectively corresponding to the first audio device 212 and the second audio device 214. The second layer 220 may further include a virtual audio driver 223 for transmitting the received audio data to a multimedia application program 236.

The third layer may include an audio data rerouting module 234 for receiving audio data from the first audio driver 222 or audio data from the second audio driver 224. The audio data rerouting module 234 is configured to reroute the received audio data to the virtual audio driver 223 to allow the virtual audio driver 223 to transmit the audio data to the multimedia application program 236. Accordingly, when the settings of the audio input device are changed, the audio data can be rerouted to the audio data rerouting module 234 and transmitted to the multimedia application program 236 through the virtual audio driver 223 no matter whether the audio data is inputted through the first audio device 212 or the second audio device 214.

The multimedia application program 236 within the third layer 230 is used to process audio data. For example, the multimedia application program 230 may be implemented with a Windows Multimedia application program pioneered by the Microsoft Corporation. The multimedia application program 230 is configured to set the first audio device 212 as a default audio device, and thus the corresponding first audio driver 222 is set as the default audio driver. For the multimedia application program 236, the audio data is invariably transmitted from the virtual audio driver 223.

In the present embodiment, the audio data rerouting module 234 may further include a user interface (not shown). By the user interface, the user may set the second audio device 214 as a user-selected audio device. The audio data may be rerouted through the audio data rerouting module 234 to the virtual audio driver 223 according to the user-selected audio device (that is, the second audio device 214), and transmitted to the multimedia application program 236 for being further processed. When one of the first audio device 212 and the second audio device 214 is in a working state, the other one of the first audio device 212 and the second audio device 214 will be in an idle state in order to allow the audio data to be dynamically outputted through the first audio device 212 or the second audio device 214.

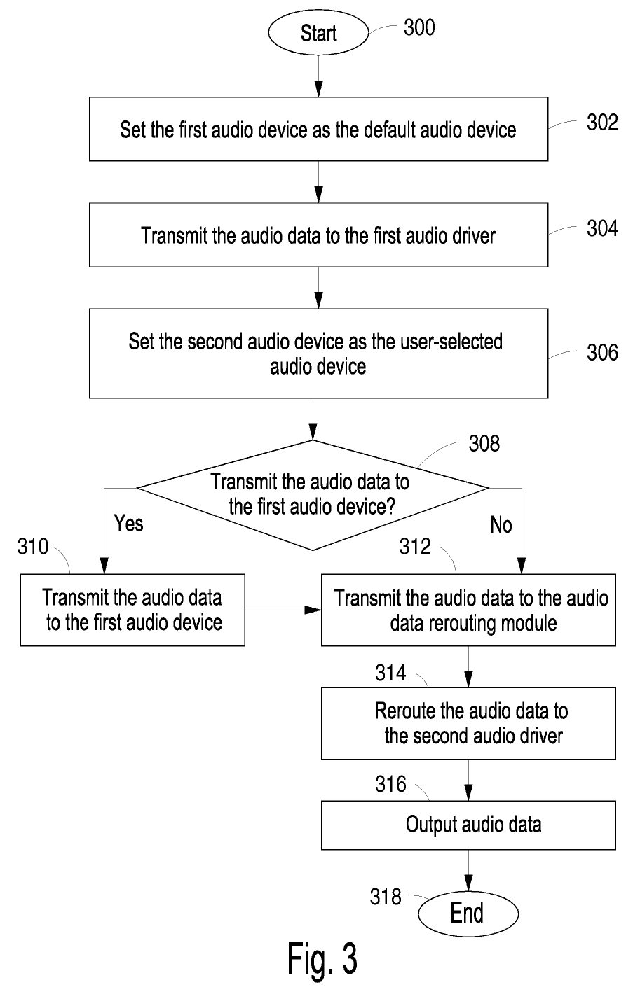

FIG. 3 illustrates a flowchart showing the audio data rerouting method according to a first embodiment of the present invention. The audio data rerouting method according to the first embodiment of the present invention is applicable to a dynamic audio data rerouting system 100 shown in FIG. 1 that includes a first audio device 112 and a second audio device 114, a first audio driver 122 and a second audio driver 124, and an audio data rerouting module 134. The procedure of the inventive audio data rerouting method according to the first embodiment is carried out by virtue of the following steps. First, the multimedia application program 132 set the first audio device 112 as the default audio device (step 302), and thereby the audio data may be transmitted to the first audio driver 122 (step 304). In the meantime, the user may use a user interface (not shown) to select the second audio device 114 as a user-selected audio device for audio data output (step 306). Next, when the first audio driver 122 receives the audio data, the audio data will be determined whether to be transmitted to the corresponding first audio device 112 or not (step 308). If yes, the audio data will be transmitted to the first audio device 112 (step 310). Otherwise, the first audio driver 122 may transmit the audio data to the audio data rerouting module 134 (step 312). Next, the audio data rerouting module 134 may reroute the audio data to the user-selected second audio driver 124 (step 314), and thereby outputting the audio data through the second audio device 114 (step 316).

In the present embodiment, the audio data rerouting module 134 may automatically detect the user settings of the audio input/output device. Therefore, the audio data rerouting module 134 may reroute the received audio data to the audio driver being corresponding to user-selected audio device. However, the data rerouting module 134 may be driven by other programs to reroute the received audio data to the audio driver being corresponding to user-selected audio device.

Furthermore, when one of the first audio device 112 and the second audio device 114 is in a working state, the other one of the first audio device 112 and the second audio device 114 will be in an idle state in order to allow the audio data to be dynamically outputted through the first audio device 112 or the second audio device 114. In the case that the first audio device 112 is in the working state and the second audio device 114 is selected by the user, the audio data received by the first audio driver 122 may be rerouted through the audio data rerouting module 134 to the second audio driver 124 so as to redirect the audio data to the second audio device 114.

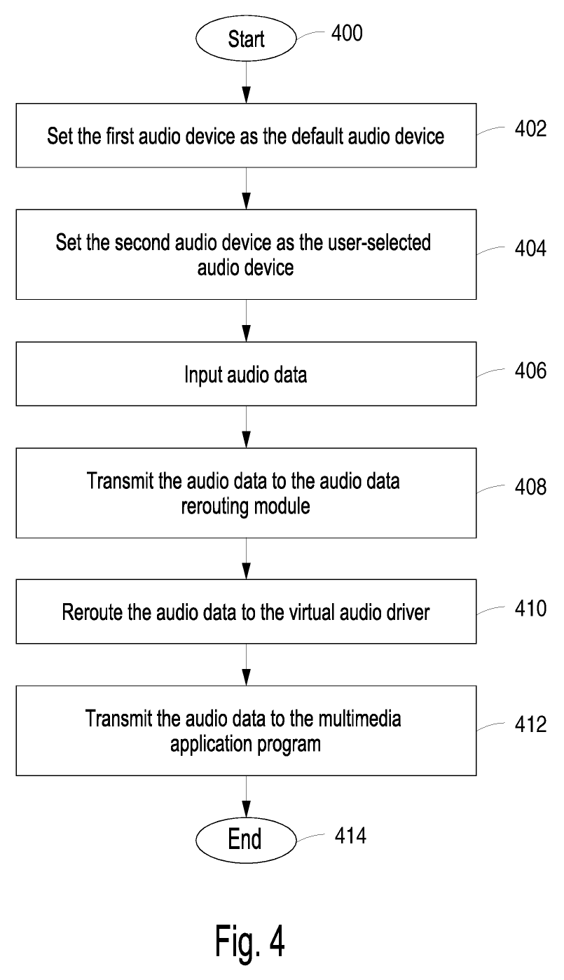

FIG. 4 illustrates a flowchart showing the audio data rerouting method according to a second embodiment of the present invention. The audio data rerouting method according to the second embodiment of the present invention is applicable to a dynamic audio data rerouting system 200 shown in FIG. 2 that includes a first audio device 212 and a second audio device 214, a first audio driver 222 and a second audio driver 224, and an audio data rerouting module 234. The procedure of the inventive audio data rerouting method according to the second embodiment is carried out by virtue of the following steps. First, the multimedia application program 236 may set the first audio device 212 as the default audio device (step 402). While the audio data is inputted through the first audio device 212, the user may use a user interface (not shown) to select the second audio device 214 as a user-selected audio device (step 404). Next, no matter whether the audio data is inputted through the first audio driver 222 or the second audio driver 224, the audio data will be inputted and transmitted to the audio data rerouting module 234 (step 406 and step 408). Next, the audio data rerouting module 234 may reroute the received audio data to the virtual audio driver 223 (step 410). Next, the virtual audio driver 223 may transmit the audio data to the multimedia application program 236 (step 412). Accordingly, when it is desired to dynamically change the input device for the audio data, the audio data will be transmitted to the audio data rerouting module 236 no matter whether the audio data is inputted through the first audio device 212 or the second audio device 214, so that the audio data may be transmitted through the virtual audio driver 223 to the multimedia application program 236. Moreover, when one of the first audio device 212 and the second audio device 214 is in the working state, the other one of the first audio device 212 and the second audio device 214 will be in the idle state in order to allow the audio data to be dynamically inputted through the first audio device 212 or the second audio device 214.

While the present invention has been described in terms of what are presently considered to be the most practical and preferred embodiments, it is to be understood that the present invention need not be restricted to the disclosed embodiment. On the contrary, it is intended to cover various modifications and similar arrangements included within the spirit and scope of the appended claims which are to be accorded with the broadest interpretation so as to encompass all such modifications and similar structures. Therefore, the above description and illustration should not be taken as limiting the scope of the present invention which is defined by the appended claims.

What is claimed is:

1. A dynamic audio data rerouting system comprising:
a first audio device and a second audio device;
a first audio driver and a second audio driver being respectively corresponding to the first audio device and the second audio device; and
an audio data rerouting module;
wherein when the first audio device is in use, the audio data received by the first audio driver is rerouted to the second audio driver through the audio data rerouting module so as to redirect the audio data to the second audio device.

2. The dynamic audio data rerouting system according to claim 1 further comprising a multimedia application program for setting the first audio device as a default audio device.

3. The dynamic audio data rerouting system according to claim 2 wherein the multimedia application program is configured to transmit the audio data to the first audio driver.

4. The dynamic audio data rerouting system according to claim 1 further comprising a user interface for allowing a user to set the second audio device as a user-selected audio device.

5. The dynamic audio data rerouting system according to claim 1 wherein the first audio driver is configured to selectively route the audio data to the first audio device or the audio data rerouting module.

6. The dynamic audio data rerouting system according to claim 4 wherein the audio data rerouting module is configured to automatically detect the user settings of audio device.

7. The dynamic audio data rerouting system according to claim 1 wherein both of the first audio device and the second audio device are an audio output device.

8. The dynamic audio data rerouting system according to claim 1 wherein when one of the first audio device and the second audio device is in a working state, the other one of the first audio device and the second audio device is in an idle state.

9. A dynamic audio data rerouting system comprising:
a first audio device and a second audio device;
a virtual audio driver;
a multimedia application program; and
an audio data rerouting module;
wherein the audio data rerouting module is configured to reroute the audio data received by the first audio device or the second audio device to the multimedia application program through the virtual audio driver.

10. The dynamic audio data rerouting system according to claim 9 further comprising a first audio driver and a second audio driver being respectively corresponding to the first audio device and the second audio device.

11. The dynamic audio data rerouting system according to claim 9 further comprising a virtual audio device being corresponding to the virtual audio driver.

12. The dynamic audio data rerouting system according to claim 11 wherein the multimedia application program is configured to set the virtual audio device as a default audio device.

13. The dynamic audio data rerouting system according to claim 9 further comprising a user interface for setting one of the first audio device and the second audio device as a user-selected audio device.

14. The dynamic audio data rerouting system according to claim 9 wherein both of the first audio device and the second audio device are an audio input device.

15. The dynamic audio data rerouting system according to claim 9 wherein when one of the first audio device and the second audio device is in a working state, the other one of the first audio device and the second audio device is in an idle state.

16. A dynamic audio data rerouting architecture comprising:
a physical layer having a first audio device and a second audio device;
an audio driver layer having a first audio driver and a second audio driver being respectively corresponding to the first audio device and the second audio device; and
a multimedia application layer having an audio data rerouting module;
wherein when the first audio device is in a working state, the audio data received by the first audio driver is rerouted to the second audio driver through the audio data rerouting module so as to redirect the audio data to the second audio device.

17. The dynamic audio data rerouting architecture according to claim 16 wherein the multimedia application layer further comprises a multimedia application program for setting the first audio device as a default audio device.

18. The dynamic audio data rerouting architecture according to claim 17 wherein the multimedia application program is configured to transmit the audio data to the first audio driver.

19. The dynamic audio data rerouting architecture according to claim 16 wherein the multimedia application layer further comprises a user interface for allowing a user to set the second audio device as a user-selected audio device.

20. The dynamic audio data rerouting architecture according to claim 16 wherein the first audio driver is configured to selectively route the audio data to the first audio device or the audio data rerouting module.

21. The dynamic audio data rerouting architecture according to claim 19 wherein the audio data rerouting module is configured to automatically detect the user settings of audio device.

22. The dynamic audio data rerouting architecture according to claim 16 wherein both of the first audio device and the second audio device are an audio output device.

23. The dynamic audio data rerouting architecture according to claim 16 wherein when one of the first audio device and the second audio device is in a working state, the other one of the first audio device and the second audio device is in an idle state.

24. A dynamic audio data rerouting architecture comprising:
a physical layer having a first audio device and a second audio device;
an audio driver layer having a virtual audio driver; and
a multimedia application layer having a multimedia application program and an audio data rerouting module;
wherein audio data rerouting module is configured to reroute audio data received by the first audio device or the second audio device to the multimedia application program through the virtual audio driver.

25. The dynamic audio data rerouting architecture according to claim 24 wherein the audio driver layer further comprises a first audio driver and a second audio driver being respectively corresponding to the first audio device and the second audio device.

26. The dynamic audio data rerouting architecture according to claim 24 further comprising a virtual audio device being corresponding to the virtual audio driver.

27. The dynamic audio data rerouting architecture according to claim 26 wherein the multimedia application program is configured to set the virtual audio device as a default audio device.

28. The dynamic audio data rerouting architecture according to claim 24 wherein the multimedia application layer further comprises a user interface for setting one of the first audio device and the second audio device as a user-selected audio device.

29. The dynamic audio data rerouting architecture according to claim 24 wherein both of the first audio device and the second audio device are an audio input device.

30. The dynamic audio data rerouting architecture according to claim 24 wherein when one of the first audio device and the second audio device is in a working state, the other one of the first audio device and the second audio device is in an idle state.

31. A dynamic audio data rerouting method for use in a dynamic audio data rerouting system including a first audio device and a second audio device, a first audio driver and a second audio driver, and an audio data rerouting module, the method comprising the steps of:
transmitting audio data to the first audio driver;
selectively transmitting the audio data to the first audio device or the audio data rerouting module;
rerouting the audio data received by the audio data rerouting module to the second audio driver; and
outputting the audio data through the second audio device.

32. The dynamic audio data rerouting method according to claim 31 further comprising the step of setting the first audio device as a default audio device.

33. The dynamic audio data rerouting method according to claim 31 further comprising the step of setting the second audio device as a user-selected audio device.

34. The dynamic audio data rerouting method according to claim 33 further comprising the step of automatically detecting user settings of audio device.

35. A dynamic audio data rerouting method for use in a dynamic audio data rerouting system including a first audio device and a second audio device and a virtual audio device, a virtual audio driver, a multimedia application program, and an audio data rerouting module, the method comprising the steps of:
inputting audio data;
transmitting the audio data to the audio data rerouting module;
rerouting the audio data to the virtual audio driver; and
transmitting the audio data through the multimedia application program.

36. The dynamic audio data rerouting method according to claim 35 further comprising the step of setting the virtual audio device as a default audio device.

37. The dynamic audio data rerouting method according to claim 35 further comprising the step of setting one of the first audio device and the second audio device as a user-selected audio device.
